(19) United States
(12) Patent Application Publication
(10) Pub. No.: US 2014/0249886 A1
(43) Pub. Date: Sep. 4, 2014

(54) BILLBOARD EXPOSURE DETERMINING SYSTEM AND METHOD

(71) Applicant: Steven Mark Levinsohn, (US)

(72) Inventor: Steven Mark Levinsohn, Johannesburg (ZA)

(21) Appl. No.: 14/351,566

(22) PCT Filed: Oct. 18, 2012
(86) PCT No.: PCT/ZA2012/000073

§ 371 Date: Apr. 13, 2014

(30) Foreign Application Priority Data
Oct. 19, 2011 (ZA) 2011/07640

(51) Int. Cl. G06Q 30/02

(52) U.S. Cl. CPC G06Q 30/0201
USPC 705/7.29

(57) ABSTRACT

This invention relates to a method and system for determining probable exposure to a visual display at a particular location. The invention involves receiving object data associated with at least one object proximate, or in viewing proximity, to the visual display; and processing the received object data to determine a probable demographic profile associated with the object, wherein the determined probable demographic profiles are used to determine the exposure to the visual display.

### FIELD OF THE INVENTION

The present invention generally relates to systems, methods and devices for determining the exposure to visual displays, billboards, or signage at particular locations.

### BACKGROUND OF THE INVENTION

It is desirable to estimate the exposure of persons to visual displays such as billboards or signs which are often displayed in outdoor settings, such as along roads, highways, railways and walkways, as well as in various indoor settings, such as in malls, subway stations, railway stations, bus stations, airports, bus shelters, building lobbies, etc.

Moreover, in addition to information concerning the numbers of persons exposed to such billboards, information concerning the days and times such exposure takes place and information concerning the particular individuals so exposed is also highly desired.

In one conventional exposure determining system, a portable transmitter containing survey participant data transmits a signal to a receiver located proximally to a billboard. The received participant data is then analysed to reveal demographic data about the survey participant and data as to when and where the survey participant was located and when the survey participant was exposed to the message on the billboard.

Another conventional system for measuring exposure to a visual display such as a billboard makes use of a transmitter that is proximate to the billboard that transmits a signal containing data relating to the billboard to a portable receiving device that has been provided to a defined consumer population. The receiving device is adapted to recover the data signal form the transmitter and to store the information relating to the billboard when the viewer is in the pre-defined exposure area. The recorded information is subsequently downloaded for processing by a central processing facility.

It would be desirable if exposure to a billboard or sign may be determined in at least a more robust and dynamic manner without a need for some target audience members carrying transmitters and or receivers.

### SUMMARY OF THE INVENTION

According to a first aspect of the invention there is provided a method for determining probable exposure to a billboard at a particular location, the method comprising:
identifying at least one non-human object associated with at least one human travelling proximate to the billboard;
determining a probable demographic profile of the human associated with the identified object by using demographic data associated with at least one human usually or probably associated with a non-human object similar to the identified object, wherein the demographic data at least comprises one or more of age, income level, marital status, sex, and race associated with the human; and
using one or more determined probable demographic profiles to determine the probable exposure to the billboard.

The non-human objects may comprise one or more of vehicles, items of clothing, footwear, and accessories associated with a human, the method comprising receiving object data associated with the object thereby to facilitate identifying the same.

The method may comprise the steps of:
determining a presence of an object travelling proximate, or in viewing proximity, to the billboard; and
receiving or capturing object data associated with the object in response to determining the presence thereof, the object data comprising one or more image of the object.

The method may further comprise the steps of:
assigning an identifier to each determined probable demographic profile thereby to identify the same or the associated object;
associating each identified probable demographic profile with the corresponding billboard, or data displayed thereby, in a profile database;
generating or determining an probable exposure profile of the billboard, or data displayed thereby, wherein the probable exposure profile of the billboard comprises probable demographic profiles of a plurality of objects associated with the billboard, or data displayed thereby; and
using the generated or determined probable exposure profile associated with the billboard, or data displayed thereby, to determine the exposure thereto.

In a preferred example embodiment, the method may comprise:
receiving or determining visibility data associated with visibility of the object relative to the billboard, or data displayed thereby, wherein the visibility data comprises information indicative of one or more of direction of travel of the object relative to the billboard, distance of the object relative to the billboard, time of day, light conditions proximate to the billboard, weather conditions proximate the billboard and speed of travel of the object relative to the billboard; and
using the visibility data to determine the exposure to the billboard, or data displayed thereby, wherein the probable exposure profile of the billboard optionally comprises the visibility data.

The method may comprise using the probable exposure profile associated with the billboard, or data displayed thereby, to determine one or more premium for displaying the data by way of the billboard, wherein the premium comprises one or more of a cost for displaying the data by way of the billboard, a weighting to be applied to the cost, and a discount to be applied to the cost.

The premium may be determined by using a cost schedule or weighting such that the premiums are varied depending on the probable exposure profile associated with the billboard, or data displayed thereby.

The method may comprise:
comparing demographic data for probable demographic profiles associated with objects travelling proximate the billboard, or associated with an probable exposure profile associated with the billboard, or data displayed thereby, with corresponding demographic data associated with the cost schedule; and
determining the premium based on the comparison.

In one example embodiment, the method may comprise:
applying an object identification or recognition algorithm to the received or captured image thereby to identify the object, or facilitate identification thereof;
comparing the identified object, or data associated therewith, with data associated with a plurality of objects stored in a demographic data database, wherein the demographic data database stores data associated with a plurality of non-human objects including demographic data associated respectively therewith; and
retrieving demographic data associated with a matched similar object from the demographic data database for determining, in use, a probable demographic profile of one or both of the identified object and the human associated therewith.

The method may also comprise the steps of:
applying an image processing algorithm to the captured image to identify the object aspects of the object which is related to at least one particular entity associated therewith;
using the identified aspects of the object which is related to the particular entity to interrogate an identification database thereby at least to determine location data indicative of a location of residence or place of business associated with the entity; and
using the determined location data to determine, from the demographic data database, a probable demographic profile associated with the entity.

According to a second aspect of the invention there is provided a system for determining exposure to a billboard, the system comprising:
at least one demographic data database storing, for a plurality of non-human objects, data associated with the non-human objects including demographic data associated with at least one human usually associated with the non-human objects, wherein the demographic data at least comprises one or more of age, income level, marital status, sex, and race associated with the humans;
at least one object identifier module configured to identify at least one non-human object associated with at least one human travelling proximate to the billboard; and
at least one data processor configured to determining a probable demographic profile of the human associated with the identified object by using demographic data of similar a non-human object stored in the database, wherein one or more determined probable demographic profiles are used to determine the exposure to the billboard.

The non-human objects may comprise one or more of vehicles, items of clothing, footwear, and accessories associated with a human.

The system may comprise:
an object detection module configured to determine a presence of an object travelling proximate, or in viewing proximity, to the billboard; and
a data capturing module configured to capture object data associated with the object in response to the object detection module determining the presence thereof, the object data comprising one or more image of the object.

It will be appreciated that in some example embodiment, the system may comprise:
an identification module configured to assign an identifier to the probable demographic profile thereby to identify the same or the associated object;
an association module configured to associate each identified probable demographic profile with the corresponding billboard, or data displayed thereby, in a profile database; and
an probable exposure profile generator module configured to generate or determine an probable exposure profile of the billboard, or data displayed thereby, wherein the probable exposure profile of the billboard comprises probable demographic profiles of a plurality of objects associated with the billboard, or data displayed thereby, and wherein the generated or determined probable exposure profiles are used to determine the exposure to the respective billboards, or data displayed thereby.

The system may comprise a visibility data module configured to receive or determine visibility data associated with visibility of the object relative to the billboard, or data displayed thereby, wherein the visibility data comprises information indicative of one or more of direction of travel of the object relative to the billboard, distance of the object relative to the billboard, time of day, light conditions proximate to the billboard, weather conditions proximate the billboard and speed of travel of the object relative to the billboard; wherein the probable exposure profile generator module is configured to use the visibility data to generate or determine the probable exposure profile of the billboard.

The system may also advantageously comprise a billing module configured to use the probable exposure profile associated with the billboard, or data displayed thereby, to determine one or more premium for displaying the data by way of the billboard, wherein the premium comprises one or more of a cost for displaying the data by way of the billboard, a weighting to be applied to the cost, and a discount to be applied to the cost.

The billing module may be configured to determine the premium by using a cost schedule such that the premiums are varied depending on the probable exposure profile associated with the billboard, or data displayed thereby.

The billing module may be configured to:
compare demographic data for each probable demographic profile associated with an probable exposure profile for the billboard, or data displayed thereby, with corresponding demographic data associated with the cost schedule; and
determine the premium based on the comparison.

The system may further comprise:
an image processor module configured to apply an object identification or recognition algorithm to the received or captured image thereby to identify the object, or facilitate identification thereof; and
an object comparator module configured to compare the identified object, or data associated therewith, with data associated with a plurality of objects stored in the demographic data database, such that the data processor is configured to retrieve demographic data associated with a matched similar object from the demographic data database for determining, in use, a probable demographic profile of one or both of the identified object and the human associated therewith.

In some example embodiments, the image processor module may be configured to apply an image processing algorithm to the received image to identify aspects of the object which is related to at least one particular entity associated therewith. In addition, the data processor may be configured to:
use the identified aspects of the object which is related to the particular entity to interrogate an identification database thereby at least to determine location data indicative of a location of residence or place of business associated with the entity; and
use the determined location data to determine, from the demographic data database, a probable demographic profile associated with the entity.

In a preferred embodiment the invention discloses at least one transmitter that transmits a signal that determines the presence of an object, compares the object to at least one object in a database, identifies an object, counts the object(s), and assigns a probable demographic profile to an object.

In addition, various weightings may be assigned to the outcome of the system and costs, weighted or not, may thereafter be assigned to the results thereof. The end result is an exposure measurement system that determines the cost of the exposure.

These and other embodiments of the invention and its particular features and advantages will become more apparent from the following detailed description of the invention with reference to the accompanying drawings.

### BRIEF DESCRIPTION OF THE DRAWINGS

FIG. 1 illustrates an outdoor billboard in accordance with the invention;

FIG. 2 illustrates an indoor billboard in accordance with the invention;

FIG. 3 illustrates a schematic diagram of an example embodiment of the invention;

FIG. 4 illustrates an example embodiment of the processing system and method in accordance with the invention;

FIG. 5 illustrates an additional processing system and method in accordance with an example embodiment of the invention;

FIG. 6 illustrates an indoor billboard processing system and method in accordance with an example embodiment of the invention;

FIG. 7 is a schematic diagram illustrating a method in accordance with one example embodiment of the invention;

FIG. 8 shows a schematic diagram of a system in accordance with an example embodiment of the invention;

FIG. 9 shows another schematic diagram of a system in accordance with an example embodiment of the invention;

FIG. 10 shows a high level flow diagram of a method in accordance with an example embodiment of the invention;

FIG. 11 shows another high level flow diagram of a method in accordance with an example embodiment of the invention;

FIG. 12 shows a diagrammatic representation of a machine in the example form of a computer system in which a set of instructions for causing the machine to perform any one or more of the methodologies discussed herein, may be executed.

### DESCRIPTION OF THE INVENTION

In the following description, for purposes of explanation, numerous specific details are set forth in order to provide a thorough understanding of an embodiment of the present disclosure. It will be evident, however, to one skilled in the art that the present disclosure may be practiced without these specific details.

The term “transmitter” as used herein means any device which transmits, radiates or distributes a signal, whether optical, video, filmed, radar, sonar, ultrasound, visual, infrared, acoustic, electric, magnetic, electromagnetic or otherwise manifested, whether digital and or analogue or otherwise manifested.

The term “receiver” as used herein means any device which acquires and or captures a signal(s) and or image(s) or a series of images (such as video images), whether visual, optical, radar, sonar, infrared, filmed, ultrasound, acoustic, electric, magnetic, electromagnetic or otherwise manifested, whether digital and or analogue or otherwise manifested. The receiver may use a photographic lens and associated imaging device(s) to capture images including images of vehicles and or people.

When used in appropriate context the term “device” means any transmitter and or receiver. Otherwise, the term device refers to the type of device described.

The term “circulation” includes traffic counts and or traffic audits and vice versa, and includes vehicle traffic counts and pedestrian traffic counts, whether indoors and or outdoors.

The term “object” includes vehicles and or people.

The term “image” includes a single image or a series of images, whether digital or analogue, whether on film or video.

In this specification “to film” or to “video” means to capture an image, or a sequence of images, in a suitable manner, including chemical, magnetic or optical, and either in analogue or digital form; and “filming” and “film” or “videod” and “video” (as a verb) have corresponding meanings. The filming or videoing of an image or a sequence of images may be achieved and or recorded by a camera. A camera includes recording the image of an object on a light-sensitive material or by a camera which is an electronic device for capturing images and converting them into electrical impulses (analogue and or digital) or by other suitable means.

The term “road” includes roads, streets, highways, railways, walkways and other like places.

The term “indoor environment” includes various indoor settings, such as in malls, subway stations, railway stations, bus stations, airports, bus shelters, building lobbies and other like places.

The terms “coupled”, “coupled to” and “coupled with” as used herein means a relationship between or among two or more devices, apparatus, files, programs, media, components, networks, systems, subsystems and or means, comprising any one or more of (a) a connection whether direct or indirect or through one or more other devices, apparatus, files, programs, media, components, networks, systems, sub-systems or means, (b) a communications relationship, whether direct or indirect or through one or more other devices, apparatus, files, programs, media, components, networks, systems, sub-systems or means, or (c) a functional relationship in which the operation of any one or more thereof depends, in whole or in part, of the operation of any one or more others thereof.

The term “processor” and or “processing” as used herein means processing device(s), apparatus, programs, circuits, systems and sub-systems, whether implemented in hardware, software or both and whether for processing analogue and or digital data.

The term “module” in the context of the specification will be understood to include an identifiable portion of code, computational or executable instructions, data, or computational object to achieve a particular function, operation, processing, or procedure. It follows that a module need not be implemented in software; a module may be implemented in software, hardware, or a combination of software and hardware. Further, the modules need not necessarily be consolidated into one device but may be spread across a plurality of devices, for example, across a communication network.

The term “data” as used herein means any indicia, signals, marks, symbols, digits, letters, words, domains, symbol sets, representations and any other physical form or forms representing information, whether permanent or temporary, whether visible, audible, acoustic, electric, magnetic, electromagnetic, infrared, binary, radar, laser, optical or otherwise manifested. The term “data” as used herein to represent certain information in one physical form shall be deemed to encompass any and all representations of the same information in a different form or forms.

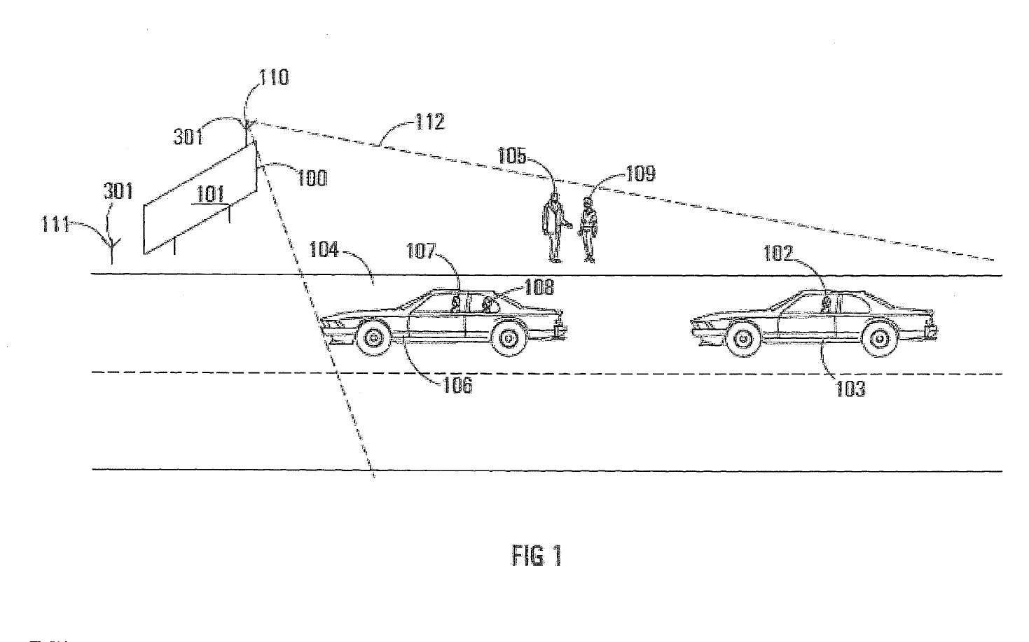

FIG. 1 illustrates an outdoor billboard 100 or sign 100 that is located near a road 104 where the message 101 displayed by the billboard is visible to at least one person 102 travelling in a vehicle 103 and or to at least one pedestrian 105.

As second vehicle 106 may also be travelling on road 104 and second vehicle 106 may contain second person 107 and third person 108 therein. Second pedestrian 109 may be walking alongside road 109.

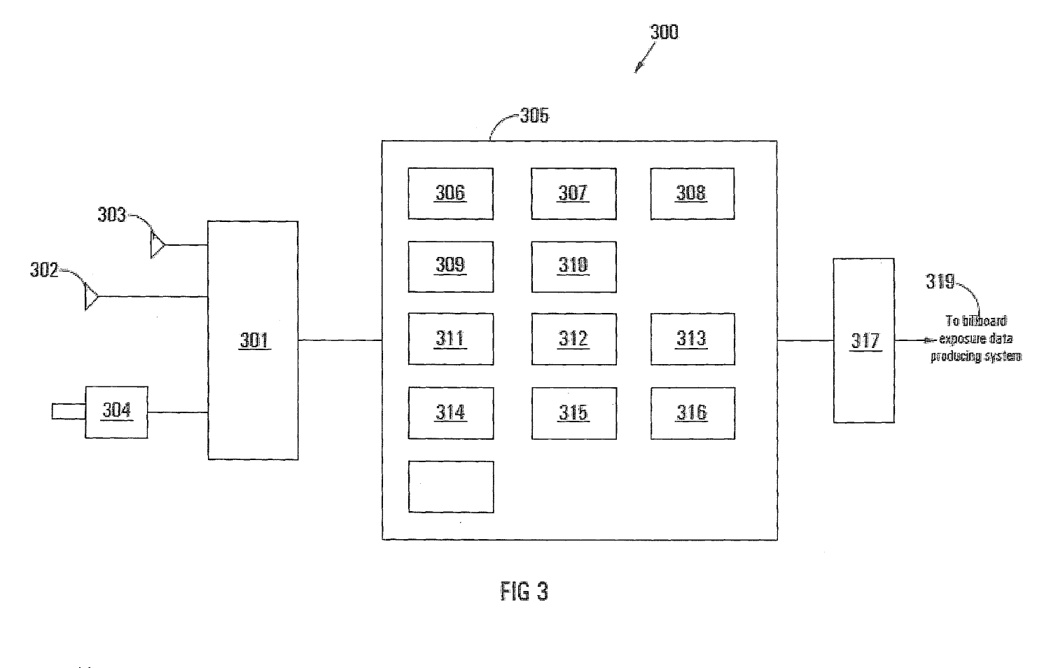

Billboard 100 contains device 110 or device 301(FIG. 3) which is a transmitter and or receiver where device 110 may be removably or permanently attached to billboard 100. Alternatively, device 111 (301) (FIG. 3), which is a transmitter and or receiver, may be located proximally to billboard 100 or device 111 may be located some distance from billboard 100. Device 111 may be permanently or removably located proximally to billboard 100. Billboard 100 may contain at least one device 110 or it may contain a plurality of such devices 110 and or there may be one or more proximally located device(s) 111; said device(s) may operate independently of one another or in conjunction with one another and may, if necessary, collect different data. In certain embodiments, a single device 301 (FIG. 3) may be associated with more than one billboard. For example, if two billboards are located on the same road and there is no turnoff for traffic between the billboards, the data collected by device 301 (FIG. 3) may be equally applicable to both billboards.

Significantly, no vehicle or person carries a portable transmitter and or transmitter/receiver to transmit data and or to receive data from and or to devices 110 and or 111 or to any other device. As disclosed herein, demographic information is collected passively, without the express consent or use of survey participants and without the use of survey participant's transmitting devices. Also, the data contained in survey participants transmitters (as disclosed in U.S. Pat. No. 6,958,710) would have to be entered into the portable transmitting device, whereas the present invention does not require data to be entered into any device by anyone or in relation to any vehicle.

FIG. 3 schematically illustrates a system 300 for measuring the exposure of billboards to an audience and for determining the demographic characteristics of such an audience, and for determining the amount to be paid by an advertiser, based on the systems, means and methods as further described herein.

Device 301 or 101 or 111 comprises a transmitter and or receiver and may also be referred to as transmitting/receiving device 301. For illustrative purposes transmitting/receiving device 301 includes a transmitter 302 and or a receiver 303, although in practice both transmitter and receiver may be combined into a single item. Device 301 may include a data capturing device 304 such as a camera 304.

Device 301 is coupled to processor 305. Processor 305 may include a central processing unit 306, memory 307, battery 308, clock 309, electricity input 310, data base 311, facial recognition software 312, vehicle recognition software 313, vehicle database set 314, demographic facial recognition database set 315 and collected data base 316. Processor 305 is adapted to work operatively with device 301.

Data base 311 comprises numerous fields such as time field, date field, speed field, type of vehicle field, type of consumer field, unique identifier field, billboard identifier field, means of identification field, demographic field and collected data field.

In a preferred embodiment and in practice, device 311 transmits a signal in order to detect the presence of an object, which may be a vehicle or a person. For example, device 311 transmits a radar signal (signal 112 in FIG. 1) with a unique identifier attached thereto. When the transmitted radar signal (signal 112 in FIG. 1) is received back by device 311 the signal (signal 112 in FIG. 1) is transmitted to processor 305 for processing.

Processor 305 attaches a time and date and stamp (from the time field and date field which are operative with the clock 309), a unique identifier (from unique identifier field), the distance the vehicle was from device 311 and the speed at which the vehicle was travelling (from the speed field) to the determination. The ability of radar to produce the above data is well know in practice and in industry and is employed in many types of automated speed trapping devices. By using known radar and or laser technology and or other means, system 300 can determine whether a vehicle and or person is moving towards or away from a billboard. As such, only vehicles and or people moving towards the billboard, who can therefore see the indicia 101 (FIG. 1) displayed on the billboard 100 (FIG. 1), may be included in the data collected and transferred to the billboard exposure data producing system 319. Alternatively, all data can be collected and transmitted to the billboard exposure data producing system 319.

Device 301 includes a camera for acquiring images. When a vehicle is detected, system 300 triggers camera 304 which captures an image of the vehicle. The image of the vehicle is uniquely associated with the unique identifier and the information associated therewith. An image of a person 102 (FIG. 1) in the vehicle 103 (FIG. 1) may also be captured.

In an alternative embodiment, the camera 304 may be a video camera which is operable with recognition software. The recognition software searches the field of view of the video camera 304 for vehicles. If there is a vehicle in the view, the vehicle is detected and an image of the vehicle is captured.

The image(s) is/are transmitted to processor 305. The vehicle database set 314 and demographic facial recognition database set 315 have been populated in advance with unique identifying characteristics of vehicles and people, respectively.

An algorithm, such as an Eigenface algorithm, used for identifying individual human faces from still images and from video, located at 312, resides in the processor 305. Similarly, an algorithm, such as Principal Component Analysis and or a Bayesian algorithm and or an Eigenface algorithm, adapted to identifying individual vehicles, from still images and from video, located at 313 resides in the processor 305.

In a first embodiment, using the algorithm, the newly captured vehicle image is compared against the existing set of vehicle images in database set 314. The existing set of images in database set 314 may be updated from time to time in a wired or wireless manner using receiver 303 or alternative means. A match is made between the newly captured vehicle image and an existing vehicle in database set 314. Vehicle data base set 314 contains data including images of vehicles, vehicle make, vehicle model, vehicle year and other identifying attributes of vehicle, including their cost.

In another embodiment, using the algorithm, the newly captured image of the person is compared against the existing set of types of images in demographic facial recognition database set 315. The existing set of images in database set 315 may be updated from time to time in a wired or wireless manner using receiver 303 or alternative means. A match is made between the newly captured persons image and a typical or representative person in demographic facial recognition database set 315.

Data such as the vehicle make, vehicle model and vehicle year of the identified and matched newly captured vehicle is transmitted to collected data base 316, together with the unique identifier and other data associated therewith such as time, date and speed of the vehicle.

Together with the unique identifier and other data associated therewith such as time, date, speed of the vehicle and or the demographic type code of the newly captured image of the person or persons in the vehicle may be transmitted to the collected data base 316. Such demographic information may include data such as age and or age range and or gender and or other demographic information. The demographic information may be stored in demographic facial recognition database set 315.

This procedure may be repeated a plurality of time for a plurality of vehicles and the aggregate thereof may be stored in collected data base 316.

A communications device 316 is coupled to the processor 305, which communicates the data contained in collected data base 316 to a billboard exposure data producing system for producing billboard exposure data using the collected data from collected data base 316.

Communications device 317 may communicate and or transmit the collected data 316 to the billboard exposure data producing system by any of numerous means, either by wire or wireless, such as by way of satellite, telephone lines, data lines, fiber-optic cable, radio transmissions, cell-phone networks, etc.

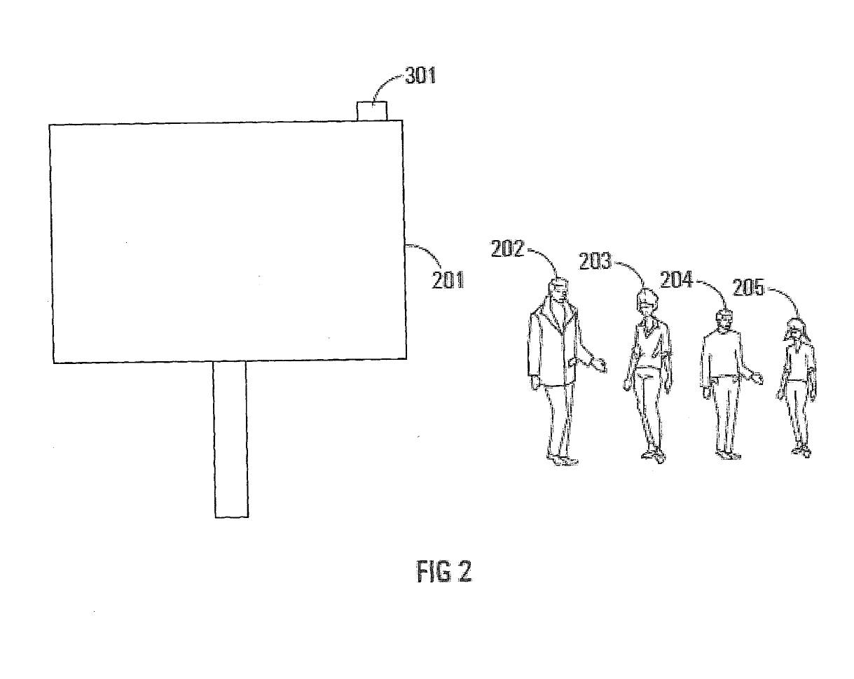

The billboard 201 (FIG. 2) may be located in a mall. System 300, including device 301, (FIG. 2) may be attached to billboard 201 (FIG. 2). Clearly, there will be no vehicles travelling in a shopping mall. However, system 300 and device 301 will be configured to determine the presence of people using the procedures describe above.

Referring to FIG. 2 and to FIG. 3, and as described above, device 305 captures an image of a first person 202, a second person 203, a third person 204 and a fourth person 205.

Demographic facial recognition database set 315 contains a set of representative images of different demographic groups such as female 18 to 45 (probable demographic profile 1), male aged 36 to 49 (probable demographic profile 2), females under 12 years old (probable demographic profile 3) and males aged 12 to 18 years old (probable demographic profile 4).

The newly captured images of persons 202, 203, 204 and 205 are compared and matched against the data located in demographic facial recognition database set 315. Using a suitable means such as an Eigenface algorithm, system 305 determines that persons 202, 203, 204 and 205 belong in probable demographic profile 1, 2, 3 and 4, respectively. This data, together with the data on the time and date that each person walked past billboard 201 and activated system 301, is uniquely transmitted to collected data base 316. As disclosed above, the data contained in collected data base 316 may then be transmitted to the billboard exposure data producing system 319.

The following may occur within system 300 or by the billboard exposure data producing system, but is explained here as if it occurred with the billboard exposure data producing system.

The billboard exposure data producing system 319 receives the data from system 305's (FIG. 3) collected data base 316 (FIG. 3) (the “Collected Data”) by wired and or by wireless means and or by other suitable means.

In a preferred embodiment billboard exposure data producing system 319 stores the Collected Data in a data base.

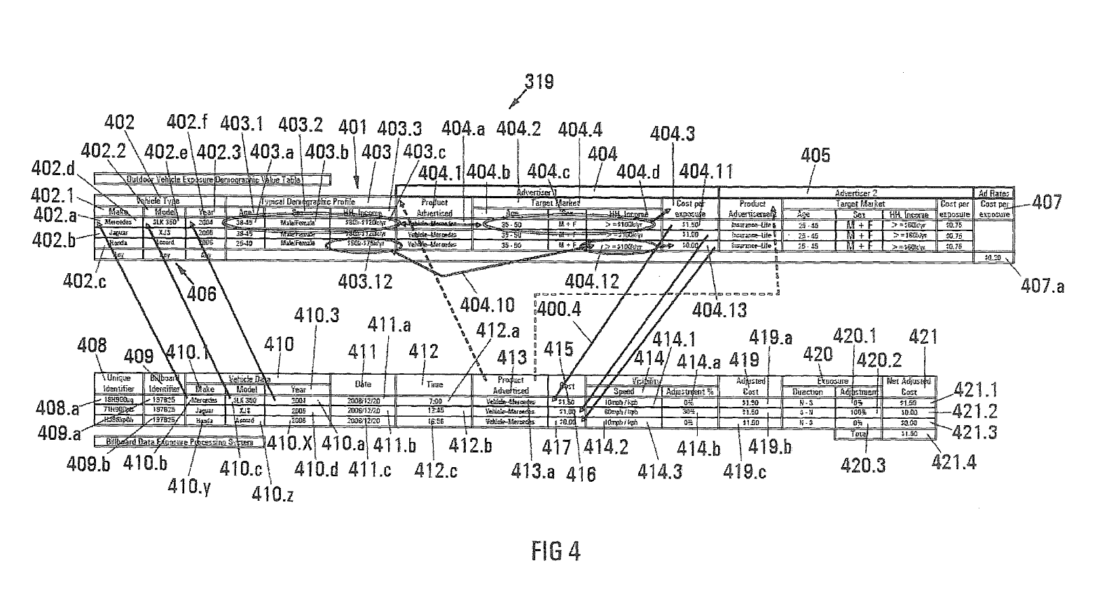

A preferred embodiment of the billboard exposure data producing and billing system 319 is illustrated in FIG. 4.

The billboard exposure data producing and billing system 319 as it relates to a vehicle exposure measurement and demographic profiling and billing system and method 400 (“vehicle exposure and demographic billing”).

The outdoor vehicle exposure demographic value table 401 (“vehicle demographic value table”) comprises data, including demographic data related to various makes and models of vehicles, that is preferably stored in a relational database.

The first set of variables or data that is stored in the vehicle demographic value table 401 may generally be classified as data that relates to vehicle type 402. The fields within the vehicle type classification may include data fields such as vehicle make 402.1, vehicle model 402.2 and vehicle year 402.3. As illustrated in FIG. 4, the vehicle type 402 database is populated with three vehicle types, listed by make, model and year, respectively, as follows: Mercedes, SLK 350, 2004 (402.a); Jaguar, XJS, 2005 (402.b); and Honda, Accord, 2006 (402.c).

A second set of variables and or data that is stored in the vehicle demographic value table 401 may generally be classified as data that relates to the typical probable demographic profile associated with the owner of a particular type of vehicle 403 (“typical probable demographic profile”).

The sellers of vehicles know who their target market for different types of vehicles are. This data is gathered and is populated in the typical probable demographic profile 403 data table which contains fields such as age 403.1, sex 403.2 and household income 403.3, such that the probable demographic profile associated with a particular make and model of vehicle is uniquely linked to that particular vehicle, as illustrated in FIG. 4.

For example, the vehicle type Mercedes, SLK 350, 2004 (402.a) has associated with it an owner whose age 403.1 is between 38 and 45 years (403.a), whose sex is male and or female (403.b) and whose annual household income is between $80,000 and $120,000 (403.c). Items 403.a, 403.b and 403.c comprise that typical probable demographic profile of a person who owns a Mercedes SLK 350 of 2004 vintage. Similarly, demographic information associated with the other vehicle types is entered into and stored in vehicle exposure and demographic billing system 400.

Also stored within vehicle exposure and demographic billing means 400 is the information related to advertisers.

The data related to advertiser 1 (404) includes fields such as the product advertised 404.1, advertiser 1's 404 target market probable demographic profile 404.2 and the amount that advertiser 1 is prepared to pay per matching exposure 404.3.

In a preferred embodiment, the amount that an advertiser is willing to pay per matching exposure may be agreed to between the advertiser and the media or billboard owner.

In an alternative preferred embodiment, advertisers can bid by way of offline or auction for the amount that they are willing to pay for matching exposures, and the highest bidder may be allocated a particular billboard by the media owner or their agent or intermediary.

In a preferred embodiment of an online or web-based auction, an auction is set up where advertisers or buyers bid for the amount that they are willing to pay per matching exposure, or for the billboard as a whole. The individual amounts for each matching exposure may be calculated according to a predetermined formula, which the bidders may be made aware of, and the highest or winning bid is awarded the rights to advertise on a particular billboard.

At the conclusion of the online auction, the amount that the winning advertiser, say advertiser 1, is prepared to pay per matching exposure 404.3 may be transmitted to system 305, wired or wirelessly, and such payment amount(s) per matching exposure will populate the appropriate data fields of cost per matching exposure 404.3.

It is therefore a preferred embodiment of the invention that advertisers may bid online for the amount that they are willing to pay for a matching exposure on a particular billboard, and that such information may be transmitted wired or wirelessly to the system 300 for use therein as further described herein.

Advertiser 1's (404) message 101 (FIG. 1) that is advertised on billboard 100 (FIG. 1) is an advertisement for a Mercedes vehicle 404.a. Advertiser 1's 404 target market probable demographic profile 404.2 includes fields such as age 404.b, sex 404.c and annual household income 404.d.

Advertiser 1's 404 target market probable demographic profile 404.2 for age 404.b, sex 404.c and annual household income 404.d, is a person 35 to 50 years old, male and or female, with an annual household income greater than $100,000, respectively.

The cost per matching exposure 404.3 field includes the amount that advertiser 1 (404) is prepared to pay for each vehicle that passes by sign 100 (FIG. 1). For a 2004 Mercedes SLK 350 advertiser 1 (404) is willing to pay $1.50; for a 2005 Jaguar XJS advertiser 1 (404) is prepared to pay $1.00 per exposure; and for a 2006 Honda Accord advertiser 1 (404) will be billed $0.00 per exposure.

Data tables and fields are set up in a similar fashion for advertiser 2 (405) as illustrated in FIG. 4.

In addition, for an unidentified vehicle and or for any other type of vehicle 406, advertisers are willing to pay the amount indicated in field ad rates 407, which amount is $0.20 (407.a) per vehicle exposed to billboard 100 (FIG. 1).

Through the means described and illustrated above, the data acquired by system 300 located in collected data base 316, is transmitted and or received by vehicle demographic value table 400, and is inputted into the appropriate data field such as a unique identifier 408, a billboard identifier 409, vehicle data 410, date 411, time 412, product advertised 413 and vehicle speed 414. Vehicle data 410 includes fields such as vehicle make 410.1, vehicle model 410.2 and vehicle year 410.3.

At a certain point in time, vehicle exposure and demographic billing system 400 processes the information that it has received from collected data base 316 and processes the data contained in system 400.

The data received from collected data base 316 is compared against the vehicle type 402 data base, the probable demographic profile data base 403 and against the advertisers database, such as advertiser 1 (404).

In a preferred embodiment system 400 is configured to work as indicated below.

At 07:00 (412.a) on 2006 Dec. 20 (411.a) a 2004 (410.a) Mercedes (410.b) SLK 350 (410.c) drove past billboard 197B25 (409.a) and is associated with unique identifier 18H90uq (408.a).

Field 410.b is compared against field 402.d for a match; field 410.c is compared against field 402.e for a match; and field 410.d is compared against field 402.f for a match. The aforementioned fields match, such that the vehicle that passed by billboard 197B25 (409.a) is a 2004 Mercedes SLK 350 which matches the 2004 Mercedes SLK 350 in vehicle type 402.

Because a match was made, system 400 then proceeds to the next step, which is to compare the probable demographic profile 403 of the matched vehicle against the advertiser's 404 target market 404.4.

The age group of the advertiser's 404 target market—35 to 50 years old—falls within the typical probable demographic profile 403 of a 2004 Mercedes SLK 350 driver—38 to 45 years old; the gender of both the advertiser 404 and the typical probable demographic profile 403 match (male and or female); and the advertiser's 404 annual household income requirement of equal to or greater than $100,000 falls within the typical probable demographic profile's 403 annual household income of $80,000 to $120,000 per year. A positive match is made.

Due to the fact that the vehicle and probable demographic profiles have matched, the system 400 looks to the cost per exposure field 404.3 and determines that advertiser 1 (404) is prepared to pay $1.50 (404.11) for said exposure. As indicated at 4004, the cost of $1.50 at 415 is billed against advertiser 1 (404) whose advertisement is for a Mercedes vehicle (404.a) and (413.a).

Similarly, the data gathered at 12.45 (412.b) on 2006 Dec. 20 (411.b) and the data gathered at 16.56 (412.c) on 2006 Dec. 20 (411.c) is compared against the data contained in the vehicle type 402 database and against the typical probable demographic profile 403 and then against the advertiser 1's (404) target market profile 404.2.

At 16:56 (412.c) on 2006 Dec. 20 (411.c) a 2006 (410.x) Honda (410.y) Accord (410.z) drove by billboard 197B25 (409.b). Advertiser 1's (404) target market probable demographic profile 404.2 is compared against the typical probable demographic profile 403 for a 2006 Honda Accord. As will be appreciated by the table illustrated in FIG. 4, advertiser 1's target market age of 35 to 50 years old matches with the typical probable demographic profile of a 2006 Honda Accord owner which is a person aged between 25 and 40. When the gender of advertiser 1's target market (male and or female) is compared against that of the typical probable demographic profile of a 2006 Honda Accord (male and or female), a match is made. However, when advertiser 1's (404) target market 404.2 annual household income 404.12 of greater than or equal to $100,000 is compared at 4040 to the typical annual household income 403.12 of $60,000 to $75,000 of a 2006 Honda Accord owner, it is clear that there is not a match. System 400 therefore refers to cost per exposure at 404.13 and at 417 charges advertiser 1 $0.00 for the 2006 Honda Accord that passed the billboard at 16:56 on 2006 Dec. 20.

In an alternative embodiment, system 400 may charge an advertiser $0.20 (407.a) for any 406 type of vehicle that passes by the billboard and or for any type of vehicle not specified by the advertiser and or for which no demographic data resides in system 400.

The result of the operation of system 400 is that for the vehicle that passed by billboard 197B25 at 07:00 on 2006 Dec. 20 advertiser 1 (404) is billed $1.50 (415); for the vehicle that passed by billboard 197B25 at 12:45 on 2006 Dec. 20 advertiser 1 (404) is billed $1.00 (416); and for the vehicle that passed by billboard 197B25 at 16:56 on 2006 Dec. 20 advertiser 1 (404) is billed $0.00 (417).

System 400 performs similar operations and determines that advertiser 1 is to be billed $1.50 (415), $1.00 (416) and $0.00 (417) for a cumulative total of $2.50.

System 400 may make adjustments to amount billed due to various factors such as the speed and direction that the vehicle was travelling.

The Mercedes at 07:00 on 2006 Dec. 20 (vehicle 1) was travelling at 10 mph 414.1 in a north to south direction past the billboard. The 2005 Jaguar XJS at 12:45 on 2006 Dec. 20 (vehicle 2) was travelling at 60 mph in a south to north direction past the billboard. The 2006 Honda Accord at 16:56 on 2006 Dec. 20 (vehicle 3) was travelling at 10 mph in a north to south direction past the billboard.

System 400 makes an adjustment of 30% (414.b) to the cost charged to advertiser 1 (404) due to the lack of visibility of the message on the billboard due to the speed 414.2 at which vehicle 2 was travelling past billboard 197B25, such that the adjusted cost 419 for vehicle 2 is $0.70 (419.b). Because vehicle 1 was travelling at 10 mph 414.1 and because vehicle 3 was also travelling at 10 mph 414.3 an adjustment of 0% (at 414.a and 414.c) is made against vehicle 1 vehicle 3, respectively. The adjusted cost for vehicles 1, 2, and 3 is $1.50, $0.70 and $0.00 at 419.a, 419.b and at 419.c, respectively.

Assuming that the message on the billboard is only visible to the occupant(s) of a vehicle travelling in a north to south direction, then because vehicle 2 was travelling in a south to north direction, the fee charged against vehicle 2 of $1.00 (416) is adjusted by 100% (420.2), such that the net adjusted cost 421 of vehicle 2 is $0.00 (421.2). Because vehicle 1 and vehicle 3 were travelling from north to south and the message on the sign was visible when travelling from north to south, no adjustment is made (at 420.1 and 420.3) to the cost.

The net adjusted cost for advertiser 1 (404) for vehicles 1, 2 and 3, is $1.50, $0.00, and $0.00 at 421.1, 421.2 and at 421.3, respectively, for a cumulative total cost to advertiser 1 of $1.50 at 421.4.

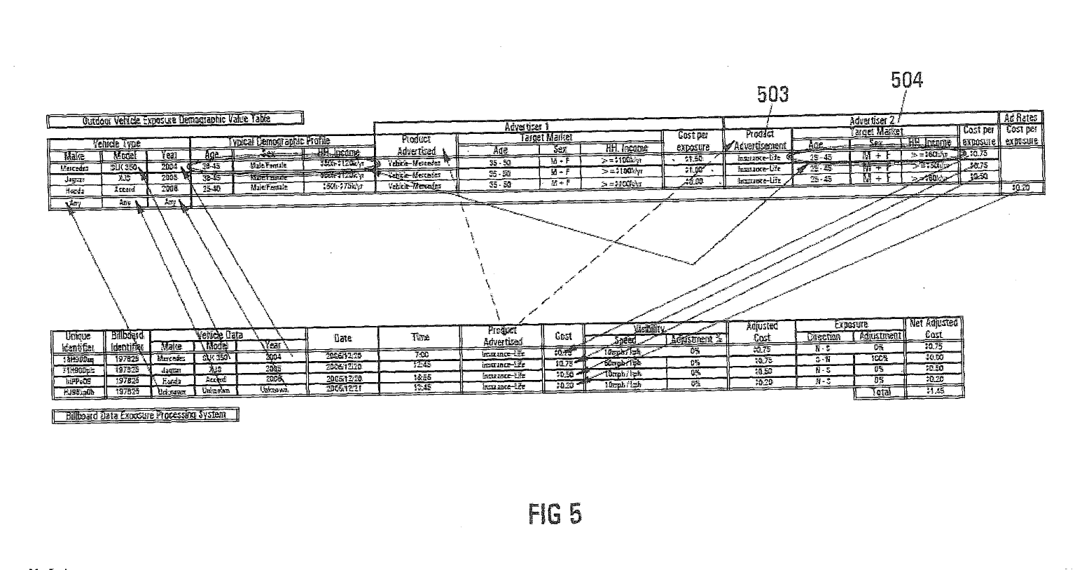

FIG. 5 illustrates on a similar basis to that in FIG. 4 the advertising cost to advertiser 2 (504) who is advertising life insurance 503. The type of vehicles that pass the billboard are compared against an existing database of the typical probable demographic profile of owners of specific vehicle types. The advertisers target market probable demographic profile is compared against the vehicles typical probable demographic profile. If a match is made, the advertiser is charged a certain amount per vehicle that passes the billboard that displays the advertisers message. A match may include an unidentified and or any type of vehicle. The cost to the advertiser may be adjusted for items such as the speed and direction that the vehicle was travelling in.

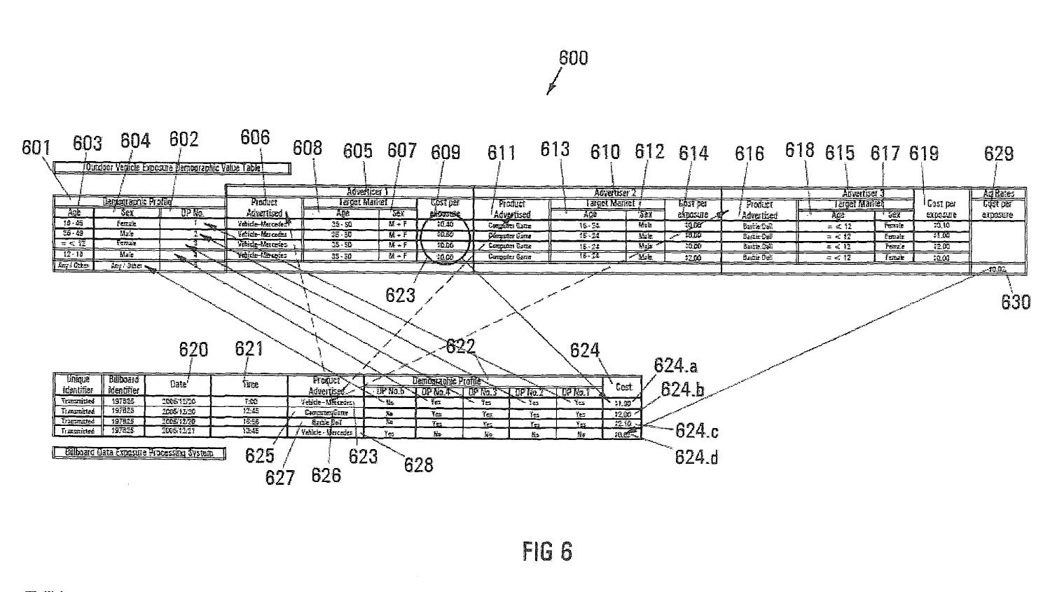

In FIG. 6, a preferred embodiment for an indoor billboard exposure management and billing system 600 is described.

The indoor billboard exposure management and billing system 600 receives the data from system 305's (FIG. 3) collected data base 316 (FIG. 3) (the “Collected Data”) by wired and or by wireless means and or by other suitable means.

In FIG. 6, the data contained in collected data base 316 (FIG. 3) (the “Collected Data”) comprises the probable demographic profiles of the people that walked past the billboard, together with the data on the time and date that each person walked past billboard 201 (FIG. 2) as described with reference to FIG. 2 and FIG. 3.

The essential functioning of the embodiment described in FIG. 4 is similar to that described in FIG. 6 and as such FIG. 6 will not be described in as much detail as the description of FIG. 4.

Indoor billboard exposure management and billing system 600 contains the probable demographic profiles 601 of five different types of demographics 602. The probable demographic profiles are divided by age 603 and gender 604 as illustrated in Table 1.

Advertiser 1 605 is advertising a Mercedes and the target market is males and females 607 between the ages of 35 and 50 (608). The cost per exposure indicates the amount that the advertiser is prepared to pay per exposure 609 to the advertisement 606 by probable demographic profile 602.

Advertiser 2 610 is advertising a Computer Game 611 and the target market is males 612 between the ages of 16 and 24 (613). The cost per exposure indicates the amount that the advertiser is prepared to pay per exposure 614 to the advertisement 611 by probable demographic profile 602.

Advertiser 3 615 is advertising a Barbie Doll 616 and the target market is females 617 under the age of 12 (618). The cost per exposure 619 indicates the amount that the advertiser is prepared to pay per exposure 619 to the advertisement 616 by probable demographic profile 602.

The Collected Data is received by indoor billboard exposure management and billing system 600 and is populated in Table 2 and includes the date 620 and time 621 that a person viewed the message displayed by billboard 201 (FIG. 2) as well as the probable demographic profile that the person fits in to 622.

As indicated in Table 2, four people walked past the billboard displaying a Mercedes advertisement 623 at 7:00 (621) on 2006 Dec. 20 (620) (“exposure A”). According to the Collected Data, the people fell into probable demographic profiles (622) 1, 2, 3 and 4 and did not fall into probable demographic profile 5.

The data contained in the fields of the probable demographic profile 622 in Table 2 of the people who walked past the billboard is then compared against the probable demographic profile 601 in Table 1.

As a result of the comparison, advertiser 1 (605) is prepared to pay the amount indicated in cost per exposure 609 for each probable demographic profile 602. Advertiser 1 is prepared to pay $0.40 for reaching probable demographic profile 1, $0.60 for reaching probable demographic profile 2, $0.00 for reaching probable demographic profile 3, and $0.00 for reaching probable demographic profile 4, as indicated at 609.

Because only probable demographic profiles 1 and 2 are a match (comparing 607 and 608 to 604 and 603, respectively) the matched costs per exposure 623 are aggregated and populated in costs to the advertiser 624 at 624.a. The total cost to advertiser 1 for exposure A is $1.00.

Because the billboard can display a plurality of messages, the audience for each message must be measured. In this example, the billboard displays three different messages.

As indicated in Table 2, four people walked past the billboard displaying a Computer Game advertisement 625 at 12:45 (621) on 2006 Dec. 20 (620) (“exposure B”). According to the Collected Data, the people fell into probable demographic profiles (622) 1, 2, 3 and 4 and did not fall into probable demographic profile 5.

The data contained in the fields of the probable demographic profile 622 in Table 2 of the people who walked past the billboard is then compared against the probable demographic profile 601 in Table 1.

As a result of the comparison, advertiser 2 (610) is prepared to pay the amount indicated in cost per exposure 614 for each probable demographic profile 602. Advertiser 2 is prepared to pay $0.00 for reaching probable demographic profile 1, $0.00 for reaching probable demographic profile 2, $0.00 for reaching probable demographic profile 3, and $2.00 for reaching probable demographic profile 4, as indicated at 614. This is because the target market for computer games is young males.

Because only probable demographic profile 4 is a match (comparing 612 and 613 to 604 and 603, respectively) the matched costs per exposure 626 are aggregated and populated in costs to the advertiser 624 at 624.b. The total cost to advertiser 2 for exposure B is $2.00.

As indicated in Table 2, four people walked past the billboard displaying a Barbie Doll advertisement 627 at 16:56 (621) on 2006 Dec. 20 (620) (“exposure C”). According to the Collected Data, the people fell into probable demographic profiles (622) 1, 2, 3 and 4 and did not fall into probable demographic profile 5.

The data contained in the fields of the probable demographic profile 622 in Table 2 of the people who walked past the billboard is then compared against the probable demographic profile 601 in Table 1.

As a result of the comparison, advertiser 3 (615) is prepared to pay the amount indicated in cost per exposure 619 for each probable demographic profile 602. Advertiser 3 is prepared to pay $0.10 for reaching probable demographic profile 1, $0.00 for reaching probable demographic profile 2, $2.00 for reaching probable demographic profile 3, and $0.00 for reaching probable demographic profile 4, as indicated at 619. This is because the target market for Barbie dolls is young females.

Because probable demographic profiles 1 and 3 are a match (comparing 617 and 618 to 604 and 603, respectively) the matched costs per exposure 627 are aggregated and populated in costs to the advertiser 624 at 624.c. The total cost to advertiser 3 for exposure C is $2.10.

As indicated in Table 2, one person walked past the billboard displaying a Mercedes advertisement 628 at 13:45 (621) on 2006 Dec. 20 (620) (“exposure D”). According to the Collected Data, the person fell into probable demographic profile (622) number 5.

The data contained in the fields of the probable demographic profile 622 in Table 2 of the person who walked past the billboard is then compared against the probable demographic profile 601 in Table 1.

As a result of the comparison, advertiser 1 (605) is prepared to pay the amount indicated in cost per exposure 629 for each probable demographic profile 602. Advertiser 1 is prepared to pay $0.40 for reaching probable demographic profile 1, $0.60 for reaching probable demographic profile 2, $0.00 for reaching probable demographic profile 3, $0.00 for reaching probable demographic profile 4 and $0.20 for reaching probable demographic profile 5, as indicated at 630.

Because only probable demographic profile 5 is a match (comparing 607 and 608 to 604 and 603, respectively) the matched costs per exposure 630 is populated in costs to the advertiser 624 at 624.d. The total cost to advertiser 1 for exposure D is $0.02.

The aggregate cost to advertiser 1 is $1.02 (624.a plus 624.d).

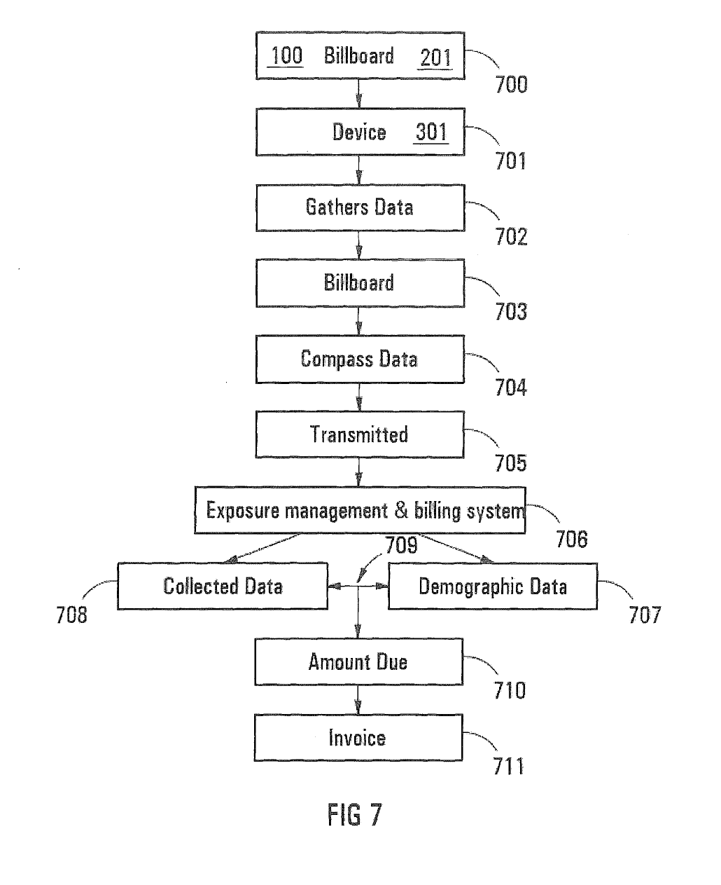

FIG. 7 illustrates a flow chart of a preferred or exemplary method of operating the invention disclosed herein.

In the first step 700 of the method, a billboard 100 (FIG. 1) and or 201 (FIG. 2) has associated therewith 701 device 301 which gathers data 702 as disclosed herein and then compares the gathered data against a predetermined set of variables 703.

The results of the comparison or matching 703 based on certain criteria are stored as Collected Data (FIG. 3) 704, which Collected Data (FIG. 3) is transmitted 705 (FIG. 3) to an exposure management and billing system 706 (as illustrated in FIG. 4, FIG. 5 and FIG. 6 and as disclosed in the specification).

Significantly, exposure management and billing system 706 contains the demographic data 707, such as the demographic target market information of an advertiser, including the type of product advertised and the cost per exposure data, as well as the probable demographic profile associated with the vehicle and or the person and or category and or grouping of vehicles and or people, as the case may be (as illustrated in FIG. 4, FIG. 5 and FIG. 6 and as disclosed in the specification) at 707.

The Collected Data is received 708 by the exposure management and billing system 706 and is stored by the exposure management and billing system 706. As illustrated in FIG. 4, FIG. 5 and FIG. 6 and as disclosed in the specification, the Collected Data 708 is compared and or parsed and or queried and or analysed against the demographic data 707 contained in the exposure management and billing system 706 (as illustrated in FIG. 4, FIG. 5 and FIG. 6 and as disclosed in the specification) at 709. If necessary, as determined by the exposure management and billing system 706, adjustments at 709, for items such as speed, visibility, direction and age, as disclosed herein, may be made to the cost of the advertising.

A total or net amount due by an advertiser is calculated and or determined 710 (as illustrated in FIG. 4, FIG. 5 and FIG. 6 and as disclosed in the specification).

The net amount due by an advertiser is communicated to the advertiser as an invoice or bill for the measured exposures 711.

The exposure management and billing system 706 may be contained within the system 300 and/or 305, or the data required therefor may be transmitted to an exposure management and billing system located remotely from exposure management and billing system 706 and/or from the billboard that uses the system as disclosed herein.

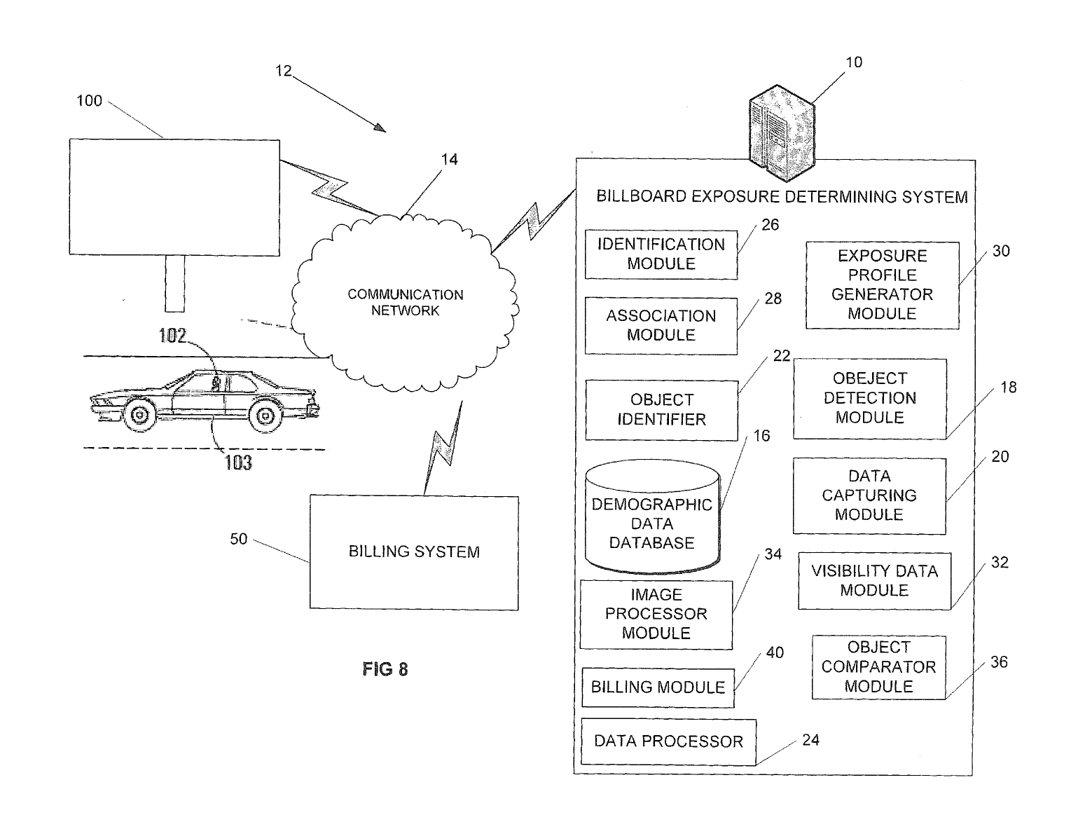

In FIG. 8, an example embodiment of a network comprising a system 10 for determining exposure to a billboard in accordance with the invention is generally indicated by reference numeral 12. The network 12 may optionally be viewed in light of the description of the systems and/or the methods described above and also optionally described with reference to the same such that similar reference numerals may be used for like components, method steps, etc.

The system 10 may receive data from the billboard 100, for example, remotely via a communication network 14. Instead, or in addition, one or more components may be located at the billboard 100. Though the system 10 is illustrated on one server, it will be understood that the components described with reference thereto may be located one more servers at differently spaced geographical locations.

The communications network 14 may be a packet-switched network and may form part of the Internet. Instead, the communications network 14 may be a circuit switched network, public switched data network, or the like. Instead, or in addition, the network 14 may comprise a mobile or cellular telecommunication network.

In any event, the system 10 comprises at least one demographic data database 16 storing, for a plurality of non-human objects, data associated with the non-human objects including demographic data (including psychometric data) associated with at least one human usually associated with the non-human objects, wherein the demographic data at least comprises one or more of age, income level, marital status, sex, and race associated with the humans. For example, the database 16 may store demographic data associated with probable owners and/or passengers 102 of a car 101.

The system 10 comprises an object detection module 18 configured to determine presence of an object travelling proximate, or in viewing proximity, to the billboard, for example the car 103. The module 18 may achieve this end in a plurality of ways as described and/or, for example, via image processing, motion sensing via infra red, ultrasonic, laser sensing, etc.

Communicatively coupled to the module 18 is a data capturing module 20 comprising at least a camera (for example, a c-mos camera, video camera, digital camera, or the like) configured to capture object data, for example, images associated with the object in response to the object detection module 18 determining the presence thereof.

The module 20 may only capture object data if the object is in a predetermined proximity to the billboard 100, for example, a predetermined distance to the billboard whereby a person is reasonably or probably likely to see the billboard 100, or data displayed thereby, for example, a certain determined meter radius from the billboard 100.

The system 10 may comprise an object identifier module 22 configured to identify the non-human object (e.g., car 103) associated with at least one human (e.g., driver or passenger 102) travelling proximate to the billboard 100. For ease of explanation, it will be noted that the non-human object may optionally be further described with respect to the car 103 which is associated with the human 102. However, it will be understood that the non-human object may be items of clothing, accessories, shoes, etc. associated with human users or purchasers thereof which may give an indication of demographics of the human 102 when compared to the usual or most probably purchaser or users of the non-human objects.

The system 10 advantageously comprises at least one data processor 24 configured to determine a probable demographic profile of the human 102 associated with the identified car 103 by using demographic data stored in the database 16 associated with similar cars 103 (make, model, etc.), or particularly probable human owners and/or passengers of these cars 103 as hereinbefore described. Probable owners 102 of the car 103 are the owners which, after market surveys, analysis, etc. are likely to purchase the car 103.

The computational elements of the system 24 may be provided in the processor 24. However, they are separately illustrated for ease of explanation and to assist in a better understanding of the invention envisaged herein.

It will be noted that the determined probable demographic profiles are used to determine the exposure to the billboard 100. The probable demographic profiles may be stored in a database or transmitted via the network 14 to another party for further processing, etc.

It will be appreciated that in some example embodiments, the system 10 comprises an identification module 26 configured to assign an identifier to the probable demographic profile thereby to identify the same or the car 103. An association module 28 is configured to associate each identified probable demographic profile with the corresponding billboard 100, or data displayed thereby, in a profile database (not shown). The profile database may form part of the database 16 as the case may be.

The system 10 also comprises an probable exposure profile generator module 30 configured to generate or determine an probable exposure profile of the billboard 100, or data displayed thereby, wherein the probable exposure profile of the billboard comprises probable demographic profiles of a plurality of objects associated with the billboard, or data displayed thereby, and wherein the generated or determined probable exposure profiles are used to determine the exposure to the respective billboards 100, or data displayed thereby. In this way, each billboard 100 associated with the system 10 may, for example, be analysed with respect to the probable demographic profiles associated with passersby or the audience to which the same is exposed to, which may be used in determining effectiveness of an advertising campaign, etc.

The system 10 may advantageously comprise a visibility data module 32, coupled or even forming part of some of the modules previously described, the module 32 being configured to receive or determine visibility data associated with visibility of the object relative to the billboard, or data displayed thereby. For example, visibility data comprises information indicative of one or more of direction of travel of the car 103 relative to the billboard 100, distance of the car 103 relative to the billboard, time of day, light conditions proximate to the billboard 100, weather conditions proximate the billboard and speed of travel of the car 103 relative to the billboard 100. The probable exposure profile generator module 30 is advantageously configured to use the visibility data to generate or determine the probable exposure profile of the billboard 100. In this way, a more robust estimation of the accuracy of exposure to the billboard 100 is achieved which is important when determining a premium for advertising via the billboard. For example, a fast travelling car 103 has a lower likelihood of the driver and/or passenger 102 actually viewing the same and receiving the message displayed thereby.

The module 32 may receive object data from the module 18 in order to determine the visibility data. In this regard, the module 18 may comprise, in addition to a camera, various sensors, e.g., radar speed sensors, etc. to determine speed of travel, of the car 103, etc. It follows that the object data may comprise more information than just images and optionally may comprise further information obtained from other sensors.

However, this need not be the case as the module 32 may conveniently determine visibility data from the captured images and/or series of images (video).

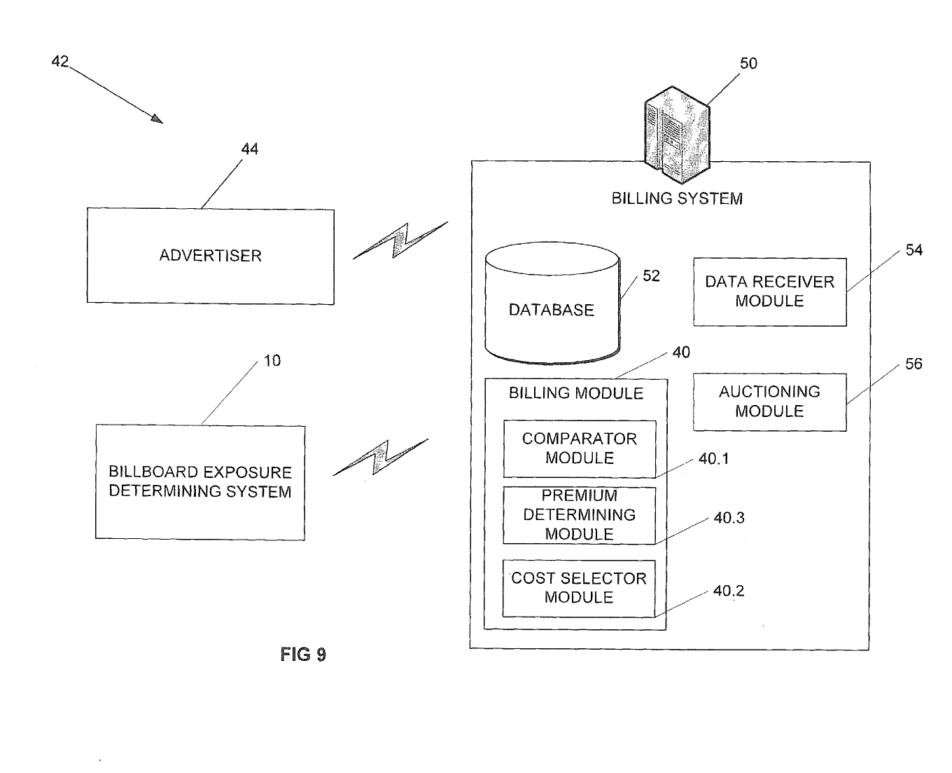

The system 10 may optionally comprise a billing module 40 configured to use the probable exposure profile associated with the billboard 100, or data displayed thereby, to determine one or more premium for displaying the data by way of the billboard 100. The billing module 40 will be described further with reference to FIG. 9.

For completeness in explanation, it will be noted that in one example embodiment of the invention, the system 10 may further comprise an image processor module 34 configured to apply an object identification or recognition algorithm to the received or captured image thereby to identify the car, or facilitate identification thereof. In this regard, it will be noted that the module 34 may also be operable to determine visibility data associated with the car 103.

The system 10 also comprises an object comparator module 36 configured to compare the identified object, or data associated therewith (e.g., make, model, colour etc), with data associated with a plurality of objects stored in the demographic data database 54, such that the data processor 24 is configured to retrieve demographic data associated with a matched similar object from the demographic data database 16 for determining, in use, a probable demographic profile of one or both of the identified car 103 and the human 102 associated therewith. In a similar fashion as described above.

To this end, the modules 22 and 32 may advantageously comprise or may be communicatively coupled to the modules 34 and 36 thereby to make use of the functionality provided thereby.

In some example embodiments, the image processor module 34 may be configured to apply an image processing algorithm to the received image to identify aspects of the car 103 which is related to at least one particular entity associated therewith. In addition, the data processor 24 may be configured to use the identified aspects of the car 103 which is related to the particular entity (human 102 or business, etc) to interrogate an identification database thereby at least to determine location data indicative of a location of residence or place of business associated with the entity. The processor 24 is then configured to use the determined location data to determine, from the demographic data database 16, a probable demographic profile associated with the entity. In this way, the system 10 can pick up on a licence plate or registration of a car and interrogate a database, e.g., a department of motor vehicles and licensing database to pull up information regarding the driver or owner of the car 103 which could comprise information indicative of their respective residence or places of business. The location of residence would have an associated probable demographic profile of residence which could be used to determine the probable demographic profile as described herein.

Determined probable exposure profiles may be used for future marketing campaigns, location profiling for future billboards, advertising, etc., or may be transmitted to a billing system 50 for further processing, for example, to charge the advertiser for displaying data by way of the billboard 100. In this regard, thought the module 40 is illustrated to be optionally part of the system 10, it may ideally be situated in the system 50. However, discussions of module 40 apply substantially to FIG. 8.

It will be understood that determining exposure to the billboard 100 comprises determining probable exposure to the billboard 100 as definite exposure may be difficult to determine with a great degree of certainty given the probable approximations and determinations made by the system 10.

In FIG. 9, an example embodiment of a network comprising the billing system 50 for billing an advertiser 46 for advertisements displayed by way of a billboard (for example, billboard 100 as described above) depending on probable exposure to the billboard 100, is generally indicated by reference numeral 42. The network 42 may optionally be viewed in light of the description of the systems and/or the methods described above (particularly FIG. 8) and also optionally described with reference to the same such that similar reference numerals may be used for like components, method steps, etc.

In any event, it will be noted that the system 50 is communicatively coupled to the system 10 as described above and the advertise 44 via a communication network, for example, network 14 (not illustrated). However, it will be appreciated that teh system 50 may form part of system 10 and vice versa. In other words the system 10 and 50 may be combined to form a larger system.

In any event, the system 50 comprises a database 52 storing data and a data receiver module 54 configured to receive at least one probable demographic profile associated with a non-human object (e.g., car 103) travelling proximate to a billboard 100, the probable demographic profile comprising demographic data associated with at least one human (e.g., passenger/driver 102) associated with the car 103, wherein the demographic data comprises one or more of age, income level, marital status, sex, and race associated with the human 102.

As alluded to previously, the system 50 advantageously comprises the billing module 40 configured to determine a premium for data displayed by the billboard by processing the received probable demographic profile with a cost schedule, wherein the cost schedule comprises at least demographic data associated with one or both of at least one human usually associated with the data being displayed and at least one object or type of object, and associated tariffs for the data displayed by the billboard 100.

It will be understood that the cost schedule may be stored in the database 52 and may from time to time be updated, automatically or on an ad hoc basis.

The premium may advantageously comprise the final cost to the advertiser 44, excluding any management or overhead fees, etc levied for use of the system 10, 50, which may be a fixed cost, a discounted cost or a weighted cost. In this way, the variable nature of the premium levied in view of the probable exposure to a particular demographic grouping advantageously provides a more robust billing for billboard advertisements as compared to fixed rate models, etc. The automated nature of this determination also takes much of the tedious location research away from advertising at a location.

The module 54 is be configured to receive an probable exposure profile associated with the billboard 100, or data displayed thereby, from the system 10, for example, wherein the probable exposure profile comprises a plurality of probable demographic profiles associated with humans associated with the non-human objects travelling proximate to the billboard, the non-human objects comprising one or more of vehicles, items of clothing, footwear, and accessories associated with a human, and visibility data as described above.

It will be appreciated that the module 40 comprises a comparator module 40.1 configured to compare one or more items of demographic data, from a probable demographic profile associated with a human 102 associated with the car 103, with corresponding demographic data from a cost schedule comprising at least demographic data associated with one or both of at least one human usually associated with the data being displayed by the billboard 100 and at least one object or type of object, and tariffs associated with the data displayed by the billboard 100, wherein the demographic data comprises one or more of age, income level, marital status, sex, and race associated with a human.

The module 40 also comprises a cost selector module 40.2 configured to select an associated tariff from the cost schedule corresponding substantially to one or more matching demographic data or profile from the comparison.

In addition, the module 40 comprises a premium determining module 40.3 configured to determine a premium for displaying data via the billboard 100 by using the selected tariff, wherein the premium comprises one or more of a cost for displaying the data, a weighting to be applied to the cost, and a discount to be applied to the cost in accordance with the selected tariff.

It will be understood that the operation of the module 40 is best described and understood with reference to FIGS. 4 to 6 and the preceding descriptions.

The comparator module 40.1 may be further configured to compare one or more items of visibility data from each received probable exposure profile with corresponding visibility data from the cost schedule. The cost selector module 40.2 may be further configured to select an associated tariff from the cost schedule corresponding substantially to one or more matching items of visibility data from the comparison by the comparator module 40.1. The premium determining module 40.3 may be configured to determine the premium by using the tariff selected by the cost selector module 40.2 in response to the comparison by the comparator module 40.1.

The system 50 may comprise an auctioning module 56 operable to receive a plurality of bids from bidders for a providing data for display via the billboard; automatically select the highest bid received for providing data for display via the billboard; and permit the bidder associated with the highest bid to provide data for displaying via the billboard. The module 56 may require the bidder to enter weightings, cost, etc. in relation to variances or variables e.g. demographics such as age, sex, vehicle, type, model, year, etc.

In some embodiments the module 54 may be configured to receive identity data indicative of an identity of at least one object proximate, or in viewing proximity, to a billboard, or data displayed thereby. In this regard, the module 40 determines the premium using the identity data, wherein the cost schedule comprises at least information indicative of identity data associated with a plurality of objects or types of objects, and associated tariffs, for the data displayed by the billboard 100.

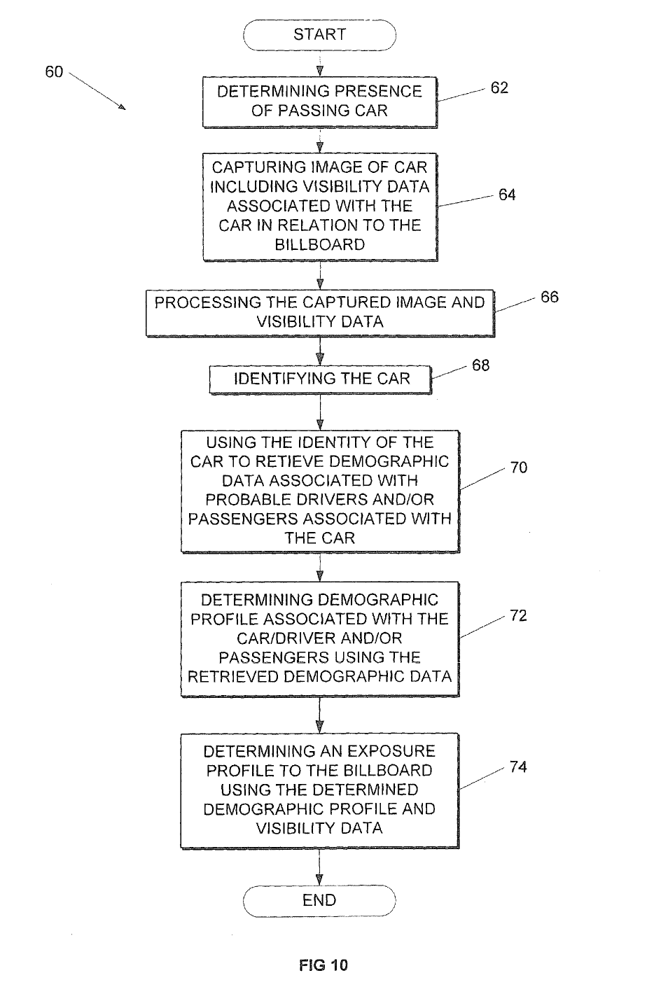

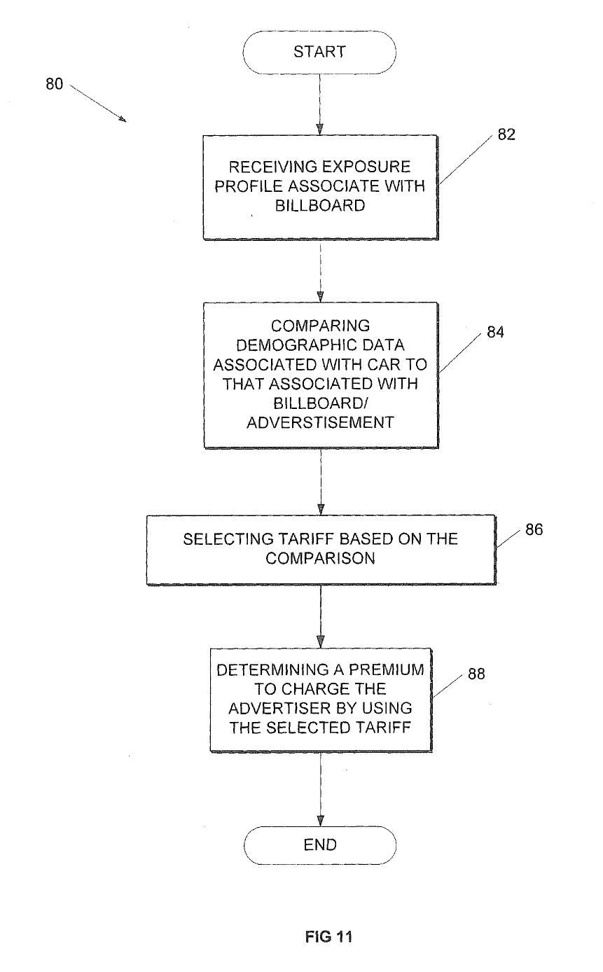

Further example embodiments will now be further described in use with reference to FIGS. 10 and 11. The example methods shown in FIGS. 10 and 11 are described with reference to FIGS. 8 and 9, although it is to be appreciated that the example methods may be applicable to other systems described herein (even those not illustrated) as well.

In FIG. 10, a flow diagram of a method in accordance with an example embodiment of the invention is generally indicated by reference numeral 60.

The method 60 relates to an, in use, scenario wherein a billboard 100 is provided at a location and a car 103 with a passenger 102 drives past the billboard 100 in relative close proximity thereto to enable a driver or passenger to reasonably see the billboard 100, or data displayed thereby.

The method 60 comprises determining, at block 62, the presence of a passing car 103 proximate to the billboard 100, by way of module 18.

The method 60 then comprises capturing, at block 64, an image of the car 103 including visibility data associated therewith by way of module 20 as hereinbefore described.

The method 60 comprises processing, at block 66, the captured image and visibility data by way of the modules described above.

The method 60 comprises identifying the car 103 at block 68 by way of module 22.

The method 60 comprises using, at block 70, the identity of the car 103 to retrieve demographic data from the database 16 associated with probable drivers or owners of the car thereby to determine, at block 72, a probable demographic profile of the driver 102 by way of at least the module 24.

The method 60 then comprises determining, at block 74, a probable exposure profile to the billboard 100 using the determined probable demographic profile together with visibility data as hereinbefore described. The probable exposure profile being used advantageously to determined probable exposure to the billboard 100.

In FIG. 11 another flow diagram of another method in accordance with an example embodiment is generally indicated by reference numeral 80.

The method 80 may be carried out by the system 50 or the system 10 (with the module 40) as the case may be.

In any event, the method 80 comprises receiving, at block 82 via module 54, a determined probable exposure profile associated with the billboard 100. The profile comprising probable demographic profiles associated with drivers 102 of cars 103 travelling proximate the billboard 100.

The method 80 comprises comparing, at block 84 by way of module 40, particularly module 40.1, demographic data associated with the car 103 (particularly the humans 102 associated therewith) with target demographic data associated with a particular advertisement displayed by the billboard 100 in accordance with a cost schedule as described above with reference to FIGS. 4 to 6.

The method 80 comprises selecting, at block 86 by way of module 40.2, a tariff from the cost schedule based on the comparison, also as hereinbefore described. The tariff may comprise a fixed cost, discount to be applied, or preferably a cost weighting as described above.

The method 80 then advantageously comprises determining, at block 88 via module 40.3, a premium to charge the advertiser 44 based on the selected tariff. It will be appreciated that this step may comprise using a cost, applying a weighting to a cost, or discount to a cost as determined by the selected tariff.

Although described with reference to one billboard 100, the system 10, 50 may be used for a plurality of billboards 100, for example as provided in a geographically spaced billboard network.

The system 10 and 50 may be combined into a single larger system which may be provided at one location or may be spread out geographically.

It will be understood by those skilled in the art that there may be various ways and embodiment in which to realise the inventions as herein described, other than those described herein. However, this should not detract from the invention described herein.

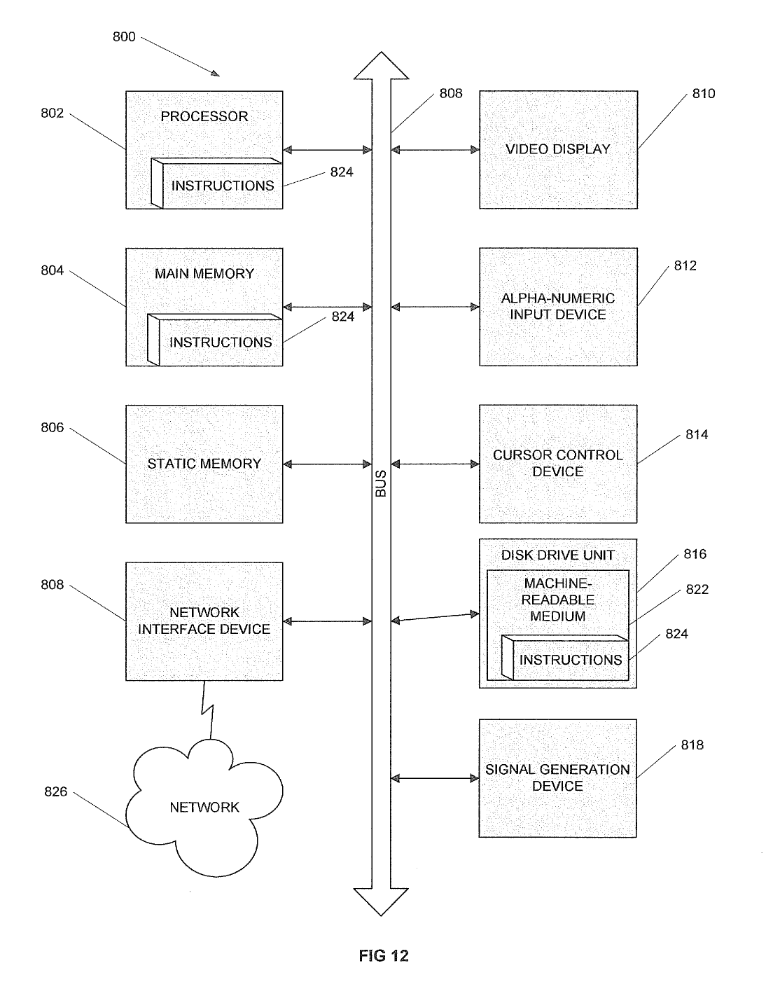

FIG. 12 shows a diagrammatic representation of machine in the example of a computer system 800 within which a set of instructions, for causing the machine to perform any one or more of the methodologies discussed herein, may be executed. In other example embodiments, the machine operates as a standalone device or may be connected (e.g., networked) to other machines. In a networked example embodiment, the machine may operate in the capacity of a server or a client machine in server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine. Further, while only a single machine is illustrated for convenience, the term “machine” shall also be taken to include any collection of machines that individually or jointly execute a set (or multiple sets) of instructions to perform any one or more of the methodologies discussed herein.

In any event, the example computer system 800 includes a processor 802 (e.g., a central processing unit (CPU), a graphics processing unit (GPU) or both), a main memory 804 and a static memory 806, which communicate with each other via a bus 808. The computer system 800 may further include a video display unit 810 (e.g., liquid crystal display (LCD) or a cathode ray tube (CRT)). The computer system 800 also includes an alphanumeric input device 812 (e.g., a keyboard), a user interface (UI) navigation device 814 (e.g., a mouse, or touchpad), a disk drive unit 816, a signal generation device 818 (e.g., a speaker) and a network interface device 820.

The disk drive unit 816 includes a machine-readable medium 822 storing one or more sets of instructions and data structures (e.g., software 824) embodying or utilised by any one or more of the methodologies or functions described herein. The software 824 may also reside, completely or at least partially, within the main memory 804 and/or within the processor 802 during execution thereof by the computer system 800, the main memory 804 and the processor 802 also constituting machine-readable media.

The software 824 may further be transmitted or received over a network 826 via the network interface device 820 utilising any one of a number of well-known transfer protocols (e.g., HTTP).

Although the machine-readable medium 822 is shown in an example embodiment to be a single medium, the term “machine-readable medium” may refer to a single medium or multiple media (e.g., a centralized or distributed database, and/or associated caches and servers) that store the one or more sets of instructions. The term “machine-readable medium” may also be taken to include any medium that is capable of storing, encoding or carrying a set of instructions for execution by the machine and that cause the machine to perform any one or more of the methodologies of the present invention, or that is capable of storing, encoding or carrying data structures utilised by or associated with such a set of instructions. The term “machine-readable medium” may accordingly be taken to include, but not be limited to, solid-state memories, optical and magnetic media, and carrier wave signals.

The present invention discloses a system and method that does not require the use of survey participants and or a defined consumer population. Further, the present invention does not require the use of a transmitting/receiving device to receive and or transmit data from a surveyed item, whether such a surveyed item is a person or a vehicle, to a receiver. Moreover, the present invention does not need a separate portable transmitting/receiving device that is carried or worn by the consumer or in or on a vehicle. Further, the present invention does not require the use of a transmitting device to transmit data from a surveyed item, whether such a surveyed item is a person or a vehicle, to a receiver. Moreover, the present invention does not need a separate portable transmitting device that is carried or worn by the consumer person or in or on a vehicle.

1. A method for determining probable exposure to a billboard at a particular location, the method comprising:
identifying at least one non-human object associated with at least one human travelling proximate to the billboard;
determining a probable demographic profile of the human associated with the identified object by using demographic data associated with at least one human usually or probably with a non-human object similar to the identified object, wherein the demographic data at least comprises one or more of age, income level, marital status, sex, and race associated with the human; and
using one or more determined probable demographic profiles to determine the probable exposure to the billboard.

2. A method as claimed in claim 1, wherein the non-human objects comprise one or more of vehicles, items of clothing, footwear, and accessories associated with a human, the method comprising receiving object data associated with the object thereby to facilitate identifying the same.

3. A method as claimed in claim 1, the method comprising:
determining a presence of an object travelling proximate, or in viewing proximity, to the billboard; and
receiving or capturing object data associated with the object in response to determining the presence thereof, the object data comprising at least one or more image of the object.

4. A method as claimed in claim 3, the method comprising the steps of:
assigning an identifier to each determined probable demographic profile thereby to identify the same or the associated object;
associating each identified probable demographic profile with the corresponding billboard, or data displayed thereby, in a profile database;
generating or determining an probable exposure profile of the billboard, or data displayed thereby, wherein the probable exposure profile of the billboard comprises probable demographic profiles of a plurality of objects associated with the billboard, or data displayed thereby; and
using the generated or determined probable exposure profile associated with the billboard, or data displayed thereby, to determine the exposure thereto.

5. A method as claimed in claim 4, the method comprising:
receiving or determining visibility data associated with visibility of the object relative to the billboard, or data displayed thereby, wherein the visibility data comprises information indicative of one or more of direction of travel of the object relative to the billboard, distance of the object relative to the billboard, time of day, light conditions proximate to the billboard, weather conditions proximate the billboard and speed of travel of the object relative to the billboard; and
using the visibility data to determine the probable exposure to the billboard, or data displayed thereby, wherein the probable exposure profile of the billboard optionally comprises the visibility data.

6. A method as claimed in claim 5, the method comprising using the probable exposure profile associated with the billboard, or data displayed thereby, to determine one or more premium for displaying the data by way of the billboard, wherein the premium comprises one or more of a cost for displaying the data by way of the billboard, a weighting to be applied to the cost, and a discount to be applied to the cost.

7. A method as claimed in claim 6, wherein the premium is determined by using a cost schedule or weighting such that the premiums are varied depending on the probable exposure profile associated with the billboard, or data displayed thereby.

8. A method as claimed in claim 7, the method comprising:
comparing demographic data for probable demographic profiles associated with objects travelling proximate the billboard, or associated with an probable exposure profile associated with the billboard, or data displayed thereby, with corresponding demographic data associated with the cost schedule; and
determining the premium based on the comparison.

9. A method as claimed in claim 3, the method comprising:
applying an object identification or recognition algorithm to the received or captured image thereby to identify the object, or facilitate identification thereof;
comparing the identified object, or data associated therewith, with data associated with a plurality of objects stored in a demographic data database, wherein the demographic data database stores data associated with a plurality of non-human objects including demographic data associated respectively therewith; and
retrieving demographic data associated with a matched similar object from the demographic data database for determining, in use, a probable demographic profile of one or both of the identified object and the human associated therewith.

10. A method as claimed in claim 8, wherein the method comprises the steps of:
applying an image processing algorithm to the captured image to identify the object aspects of the object which is related to at least one particular entity associated therewith;
using the identified aspects of the object which is related to the particular entity to interrogate an identification database thereby at least to determine location data indicative of a location of residence or place of business associated with the entity; and
using the determined location data to determine, from the demographic data database, a probable demographic profile associated with the entity.

11. A system for determining probable exposure to a billboard, the system comprising:
at least one demographic data database storing, for a plurality of non-human objects, data associated with the non-human objects including demographic data associated with at least one human usually or probably with the non-human objects, wherein the demographic data at least comprises one or more of age, income level, marital status, sex, and race associated with the humans;
at least one object identifier module configured to identify at least one non-human object associated with at least one human travelling proximate to the billboard; and
at least one data processor configured to determining a probable demographic profile of the human associated with the identified object by using demographic data of similar a non-human object stored in the database, wherein one or more determined probable demographic profiles are used to determine the probable exposure to the billboard.

12. A system as claimed in claim 11, wherein the non-human objects comprise one or more of vehicles, items of clothing, footwear, and accessories associated with a human.

13. A system as claimed in claim 11, the system comprising:
an object detection module configured to determine a presence of an object travelling proximate, or in viewing proximity, to the billboard; and
a data capturing module configured to capture object data associated with the object in response to the object detection module determining the presence thereof, the object data comprising one or more image of the object for facilitating identification of the same, in use.

14. A system as claimed in claim 13, the system comprising:
an identification module configured to assign an identifier to the probable demographic profile thereby to identify the same or the associated object;
an association module configured to associate each identified probable demographic profile with the corresponding billboard, or data displayed thereby, in a profile database; and
an probable exposure profile generator module configured to generate or determine an probable exposure profile of the billboard, or data displayed thereby, wherein the probable exposure profile of the billboard comprises probable demographic profiles of a plurality of objects associated with the billboard, or data displayed thereby, and wherein the generated or determined probable exposure profiles are used to determine the probable exposure to the respective billboards, or data displayed thereby.

15. A system as claimed in claim 14, the system comprising a visibility data module configured to receive or determine visibility data associated with visibility of the object relative to the billboard, or data displayed thereby, wherein the visibility data comprises information indicative of one or more of direction of travel of the object relative to the billboard, distance of the object relative to the billboard, time of day, light conditions proximate to the billboard, weather conditions proximate the billboard and speed of travel of the object relative to the billboard; wherein the probable exposure profile generator module is configured to use the visibility data to generate or determine the probable exposure profile of the billboard.

16. A system as claimed in claim 15, the system comprising a billing module configured to use the probable exposure profile associated with the billboard, or data displayed thereby, to determine one or more premium for displaying the data by way of the billboard, wherein the premium comprises one or more of a cost for displaying the data by way of the billboard, a weighting to be applied to the cost, and a discount to be applied to the cost.

17. A system as claimed in claim 16, wherein the billing module is configured to determine the premium by using a cost schedule such that the premiums are varied depending on the probable exposure profile associated with the billboard, or data displayed thereby.

18. A system as claimed in claim 17, wherein the billing module is configured to:
compare demographic data for each probable demographic profile associated with an probable exposure profile for the billboard, or data displayed thereby, with corresponding demographic data associated with the cost schedule; and
determine the premium based on the comparison.

19. A system as claimed in claim 13, the system comprising:
an image processor module configured to apply an object identification or recognition algorithm to the received or captured image thereby to identify the object, or facilitate identification thereof; and
an object comparator module configured to compare the identified object, or data associated therewith, with data associated with a plurality of objects stored in the demographic data database, such that the data processor is configured to retrieve demographic data associated with a matched similar object from the demographic data database for determining, in use, a probable demographic profile of one or both of the identified object and the human associated therewith.

20. A system as claimed in claim 19, wherein:
the image processor module is configured to apply an image processing algorithm to the received image to identify aspects of the object which is related to at least one particular entity associated therewith; and
the data processor is configured to:
use the identified aspects of the object which is related to the particular entity to interrogate an identification database thereby at least to determine location data indicative of a location of residence or place of business associated with the entity; and
use the determined location data to determine, from the demographic data database, a probable demographic profile associated with the entity.
